(19) United States
(12) Patent Application Publication
(10) Pub. No.: US 2013/0061222 A1
(43) Pub. Date: Mar. 7, 2013

(54) APPARATUS AND METHOD FOR MANAGING OPTIMIZED VIRTUALIZATION MODULE

(71) Applicants: Gye Seon HWANG, Seoul (KR); Wang Seok SEON, Seoul (KR)

(72) Inventors: Gye Seon HWANG, Seoul (KR); Wang Seok SEON, Seoul (KR)

(73) Assignee: PANTECH CO., LTD., Seoul (KR)

(21) Appl. No.: 13/354,045

(22) Filed: Jan. 19, 2012

(30) Foreign Application Priority Data
Sep. 7, 2011 (KR) 10-2011-0090551

(51) Int. Cl. G06F 9/455

(52) U.S. Cl. 718/1

(57) ABSTRACT

An apparatus to manage a virtualization module includes a virtualization module managing unit to retrieve a virtualization module corresponding to an application, a verification table retrieving unit to retrieve first verification data corresponding to the virtualization module from a verification table, a verification unit to verify the virtualization module, based on the first verification data and the virtualization module, and a virtual machine unit to execute, using a processor, the virtualization module a virtual machine if the virtualization module is successfully verified. A method for managing a virtualization module includes retrieving a virtualization module corresponding to an application; retrieving first verification data corresponding to the virtualization module from a verification table; verifying the virtualization module, based on the first verification data and the virtualization module; and executing, using a processor, the virtualization module using a virtual machine if the virtualization module is successfully verified.

### CROSS-REFERENCE TO RELATED APPLICATION

This application claims priority from and the benefit under 35 U.S.C. §119(a) of Korean Patent Application No. 10-2011-0090551, filed on Sep. 7, 2011, which is hereby incorporated by reference for all purposes as if fully set forth herein.

### BACKGROUND

1. Field

The following disclosure relates to an apparatus and method for managing a virtualization module, and more particularly, to an apparatus and method for managing and authenticating a virtualization module or a virtual machine executable file.

2. Discussion of the Background

A Virtual Machine (VM) refers to a software implementation of a computer that executes applications. A VM may be a virtual computer that does not communicate directly with actual hardware. A VM used in a mobile apparatus may include, for example, a Java Virtual Machine (JVM), an Android's Dalvik VM, a Low Level Virtual Machine (LLVM) used by Apple's iPhone Operating System (iOS), and the like. A purpose of a VM is to provide an independent programming environment that allows a program to be executed in the same way on any platform and abstracts away details of the underlying hardware or Operating System (OS). A VM may perform compiling to a bytecode to overcome constraints of a specific hardware or an OS, may interpret a bytecode, namely an intermediate code, during an actual operation of an application, and may execute the application. In Android's smartphones, an application may have an Android Application Package (APK) file format. Once the application is initially installed in a smartphone, the application may be executed by an Optimized DEX (ODEX) file obtained by optimizing a DEX file included in the APK file. The ODEX file may be included in a virtualization module in which a DEX file is optimized based on hardware specification, and may be a type of bytecode. Meanwhile, virus scanning may be generally performed on an APK file in smartphones, and an ODEX file may be modified by a malicious user. However, it may be inconvenient to perform virus scanning whenever the ODEX file is executed. Thus, there may be higher risks of executing malignant ODEX file without recognizing the genuine ODEX file is deteriorated or replaced by the malignant ODEX file.

### SUMMARY

Exemplary embodiments of the present invention provide an apparatus method utilizing a virtualization module that may be optimized for an apparatus used for applications in a Virtual Machine (VM) of an embedded system. The apparatus and method for managing a virtualization module may verify whether the virtualization module is modified.

Additional features of the invention will be set forth in the description which follows, and in part will be apparent from the description, or may be learned by practice of the invention.

An exemplary embodiment of the present invention provides an apparatus to manage a virtualization module, including a virtualization module managing unit to retrieve a virtualization module corresponding to an application; a verification table retrieving unit to retrieve first verification data corresponding to the virtualization module from a verification table; a verification unit to verify the virtualization module, based on the first verification data and the virtualization module; a processor; and a virtual machine unit to execute, using the processor, the virtualization module using a virtual machine if the virtualization module is successfully verified.

An exemplary embodiment of the present invention provides an apparatus to manage a virtualization module, including a downloading unit to install an application that is executable using a virtual machine; a processor; a verification data generating unit to generate, using the processor, first verification data from a virtualization module corresponding to the application; and a memory to store the first verification data and corresponding application information in a verification table, the first verification data being associated with the corresponding application information in the verification table.

An exemplary embodiment of the present invention provides a method for managing a virtualization module, including retrieving a virtualization module corresponding to an application; retrieving first verification data corresponding to the virtualization module from a verification table; verifying the virtualization module, based on the first verification data and the virtualization module; and executing, using a processor, the virtualization module using a virtual machine if the virtualization module is successfully verified.

An exemplary embodiment of the present invention provides a method for managing a virtualization module, including installing an application that is executable using a virtual machine; generating, using a processor, first verification data from a virtualization module corresponding to the application; and storing the first verification data and corresponding application information in a verification table, the first verification data being associated with the corresponding application information in the verification table.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a structure of an Android platform according to an exemplary embodiment of the present invention.

FIG. 2 is a block diagram illustrating a terminal apparatus to manage a virtualization module according to an exemplary embodiment of the present invention.

FIG. 3 is a block diagram illustrating a terminal apparatus to manage a virtualization module according to an exemplary embodiment of the present invention.

FIG. 4 is a diagram illustrating a method for generating a verification sum used to generate verification information to verify a virtualization module according to an exemplary embodiment of the present invention.

FIG. 5 is a diagram illustrating a verification table according to an exemplary embodiment of the present invention.

FIG. 6 is a flowchart illustrating a method for setting an application in a terminal apparatus according to an exemplary embodiment of the present invention.

FIG. 7 is a flowchart illustrating a method for updating an application in a terminal apparatus according to an exemplary embodiment of the present invention.

FIG. 8 is a flowchart illustrating a method for executing an application in a terminal apparatus according to an exemplary embodiment of the present invention.

FIG. 9 is a flowchart illustrating a method for setting an application in a terminal apparatus according to an exemplary embodiment of the present invention.

FIG. 10 is a flowchart illustrating a method for updating an application in a terminal apparatus according to an exemplary embodiment of the present invention.

FIG. 11 is a flowchart illustrating a method for executing an application in a terminal apparatus according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, XZZ, YZ, X).

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention relate to an apparatus and method for managing a virtualization module in an embedded system. Hereinafter, configurations of an embedded system equipped with an Android platform as exemplary embodiments will be described for convenience of description; however, it is not limited as such. The virtualization module may refer to an executable file obtained by optimizing an application for a corresponding system. The apparatus may include an operating system platform. The operating system platform may include an application, an application framework, a library, a run-time system (a runtime), and an operating system kernel.

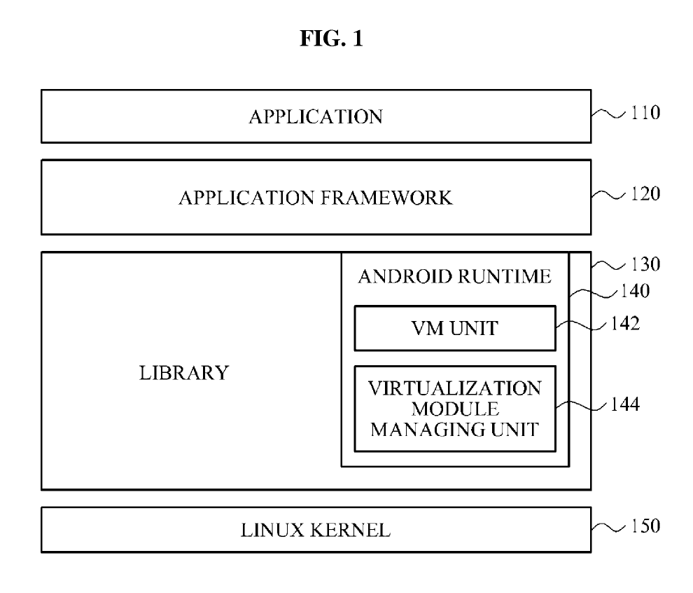

FIG. 1 is a block diagram illustrating a structure of an Android platform according to an exemplary embodiment of the present invention.

Referring to FIG. 1, the Android platform includes an application 110, an application framework 120, a library 130, an Android runtime 140, and a Linux kernel 150.

The Linux kernel 150 may manage a core system service associated with a memory, a network, a security, and a driver. The library 130 may provide various components used in the application 110 and the application framework 120. Various components provided by the library 130 may include, for example, a surface manager, a media framework, a SQLite, an Open Graphics Library for Embedded Systems (OpenGL ES), a FreeType, a Webkit, a Scene Graph Library (SGL), a Secure Sockets Layer Library (SSL), a libc (C standard library), and the like.

The application framework 120 may provide components used for a configuration and an operation of an application. The provided components may include, for example, an activity manager, a Window manager, a content provider, a view system, a notification manager, a package manager, a telephony manager, a resource manager, a location manager, an Extensible Messaging and Presence Protocol (XMPP) service, and the like.

The application 100 may include typical applications, such as Home, Contacts, Phone, and the like.

The Android runtime 140 may process an application operation using a function of Java programming. The Android runtime 140 may include a Virtual Machine (VM) unit 142, and a virtualization module managing unit 144.

The virtualization module managing unit 144 may generate verification data corresponding to an application, may manage the generated verification data, and may verify whether a virtualization module of the application is modified by a user, based on the verification data. If an application is executed, the virtualization module managing unit 144 may generate a virtualization module management object for each application and may verify the virtualization module. The virtualization module may be optimized to speed up boot process and may be optimized according to a configuration of hardware, an operating system, or a virtual machine to execute the application.

The VM unit 142 may refer to a VM designed to perform compilation and interpretation of execution-related files so that hardware may recognize installation and execution of an application. The VM unit 142 may generate an Optimized DEX (ODEX) file by optimizing a DEX file included in an Android Application Package file (APK), and may interpret information included in the DEX file and ODEX file. Further, the VM unit 142 may generate a VM object for each application in response to an application execution event, and may execute an ODEX file corresponding to each application.

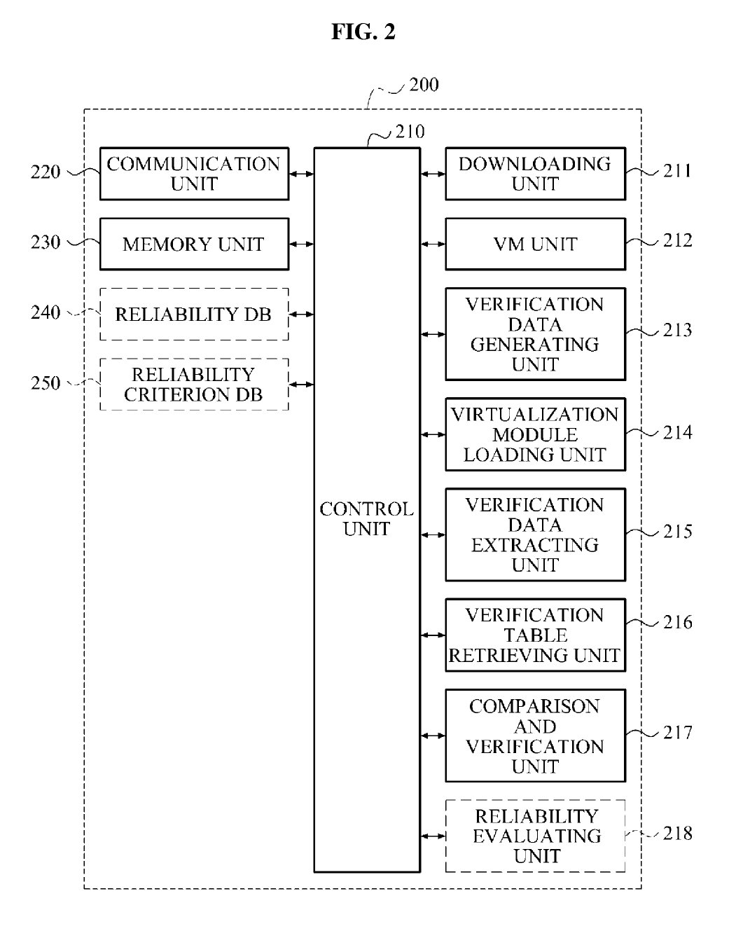

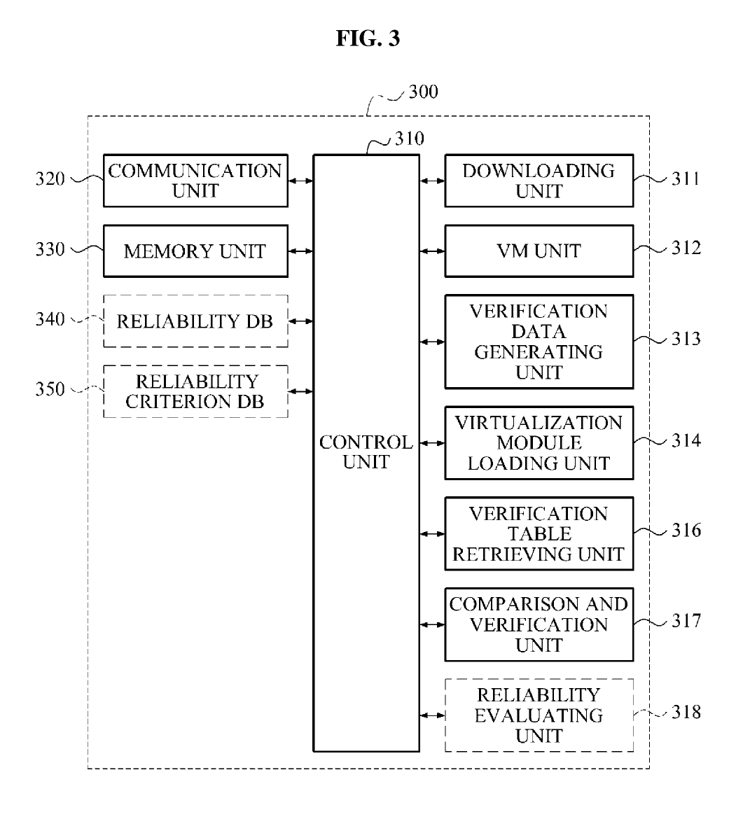

Hereinafter, the VM unit 142, and the virtualization module managing unit 144 will be further described with reference to FIG. 2 and FIG. 3.

FIG. 2 is a block diagram illustrating a terminal apparatus to manage a virtualization module according to an exemplary embodiment of the present invention.

Referring to FIG. 2, the terminal apparatus 200 includes a control unit 210, a downloading unit 211, a VM unit 212, a verification data generating unit 213, a virtualization module loading unit 214, a verification data extracting unit 215, a verification table retrieving unit 216, a comparison and verification unit 217, a communication unit 220, and a memory unit 230. Further, the terminal apparatus 200 may include at least one of a reliability evaluating unit 218, a reliability database (DB) 240, and a reliability criterion database (DB) 250.

The communication unit 220 may transmit or receive data in a wired or wireless manner. The communication unit 220 may receive at least one of an application, update data of an application, information regarding reliability of an application, and reliability criterion information used to determine reliability of an application. The reliability may refer to data integrity of an application.

The communication unit 220 may wirelessly receive or transmit data, using a wireless communication scheme based on a Frequency Division Multiple Access (FDMA), a Time Division Multiple Access (TDMA), a Space-Division Multiple Access (SDMA), a Code Division Multiple Access (CDMA), a Wideband Code Division Multiple Access (WCDMA), an Orthogonal Frequency-Division Multiplexing (OFDM), Wi-fi, Wibro, Bluetooth®, an infrared communication, or the like. The communication unit 220 for wireless communication may perform transmitting or receiving a wireless signal of data that is input or output via an antenna. For example, for data transmission, channel coding and spreading may be performed to data that is to be transmitted, and Radio Frequency (RF) processing may then be performed. Further, for data reception, a received RF signal may be converted into a baseband signal and de-spreading and channel decoding may be performed on the baseband signal, so that the data may be restored.

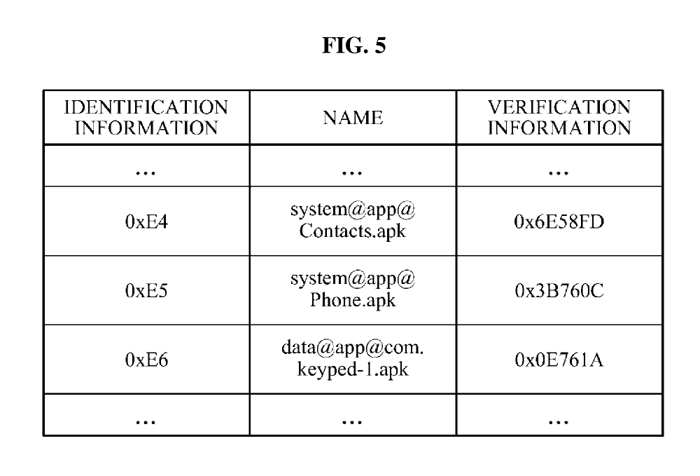

The memory unit 230 may store system data, an application, modification history information of an application, and user data. The system data may be included in an Operating System (OS) to control a portion of or all the operation of the terminal apparatus 200. Further, the user data may include, for example, a telephone number, a Short Message Service (SMS) message, a compressed image file, a moving image, and the like. The memory unit 230 may store an APK file, a DEX file, an ODEX file, and a verification table. The APK file may include an installation file used to install an application. The DEX file may include information included in the APK file, and may be a kind of bytecode to execute an application. The DEX file may be included in the APK file. The ODEX file may refer to a virtualization module generated by optimizing a DEX file for a corresponding apparatus, such as an Android-based smartphone. Further, the verification table may be used to store pieces of verification data used to verify whether each of ODEX files is modified. The verification table may be configured as shown in FIG. 5.

FIG. 5 is a diagram illustrating a verification table according to an exemplary embodiment of the present invention.

Referring to FIG. 5, the verification table may include identification information, a name, and verification information. Specifically, the identification information may be used to identify applications, and may be assigned to applications according to the installation order of each application. The name may refer to information assigned to applications while a DEX file is converted to an ODEX file, and may indicate a path in which an actual APK file is stored in the terminal apparatus 200. The verification information may be used to determine whether an ODEX file is modified or to verify the ODEX file. The verification information will be further described hereinafter in connection with the verification data generating unit 213.

The reliability DB 240 may store pieces of information regarding reliability of each application. The pieces of information stored in the reliability DB 240 may be provided from a separate server that may be used to evaluate reliability or data integrity.

The reliability criterion DB 250 may store criterion information used as a criterion to evaluate reliability or data integrity of an application. The criterion information stored in the reliability criterion DB 250 may be received from a separate server used to generate criterion information. Further, the criterion information may include at least one of a reliable category, a reliable producer, a reliable merchant server, a reliable criterion release date, and a reliable authority.

The criterion information may be associated with an application generated by a specific producer, an application that is generated prior to a specific release date of a specific producer and that is sold by a specific merchant server, an application of a specific category that is sold by a specific merchant server, an application with a specific authority among applications sold by a specific merchant server, and the like.

For example, if criterion information indicates a merchant server P, applications sold by the merchant server P may be reliable. Further, if criterion information indicates a producer A, an application generated by the producer A may be reliable. Further, if criterion information indicates a combination of the merchant server P and the producer A, an application that is generated by the producer A and that is sold by the merchant server P may be reliable.

For example, if the number of applications that are generated by the producer A and are sold by the merchant server P exceeds a reference value (i.e., 50), namely a preset reference number, and if virus, malicious software, or malicious content does not exist in the applications, the applications may be generated as criterion information by a separate server used to generate criterion information. If an application to be installed later coincides with one of the applications, the application to be installed may be determined to be reliable.

The downloading unit 211 may download an application or update data from a merchant server, under the control of the control unit 210.

The VM unit 212 may extract a DEX file from an APK file corresponding to the application downloaded by the downloading unit 211, may generate an ODEX file by optimizing the extracted DEX file, and may store the generated ODEX file in the memory unit 230.

The VM unit 212 may install the update data downloaded by the downloading unit 211. If the ODEX file is modified due to installation of the update data, the VM unit 212 may notify the verification data generating unit 213 that the ODEX file is modified.

In response to a request to execute an application, the VM unit 212 may determine whether unintentional modification occurs in an ODEX file corresponding to the application, through the comparison and verification unit 217. If it is determined that the ODEX file remains unmodified, the VM unit 212 may generate a VM object and may execute the ODEX file.

The verification data generating unit 213, the virtualization module loading unit 214, the verification data extracting unit 215, the verification table retrieving unit 216, and the comparison and verification unit 217 shown in FIG. 2 may be included in the virtualization module managing unit 144 of FIG. 1.

The verification data generating unit 213 may generate verification data, may store the generated verification data in the verification table of the memory unit 230, and may insert the generated verification data in the ODEX file. The verification data may be used to verify an ODEX file of a corresponding application. Further, the generated verification data may be inserted in a header of the ODEX file. The verification data generating unit 213 may perform one or more operations of the verification data extracting unit 215.

In response to a request to execute an application, the verification data generating unit 213 may generate verification data using an ODEX file corresponding to an application loaded by the virtualization module loading unit 214, and may provide the generated verification data to the comparison and verification unit 217.

If the ODEX file is modified due to installation of update data, the verification data generating unit 213 may generate modified verification data, and may update the verification data stored in the verification table with the modified verification data. The modified verification data may be used to verify the modified ODEX file. Further, the verification data generating unit 213 may store the modified ODEX file including the modified verification data. Further, the control unit 210 may verify the download source of update data of the installed application, and authorize update process and a modification of the verification data during the update process if the update data is verified.

The verification data generated by the verification data generating unit 213 may include verification information, namely, a unique value generated to determine whether an ODEX file is modified. Further, the verification data may include identification information used to identify an application.

The verification data generating unit 213 may use, as verification information, a checksum value obtained by performing a checksum on an ODEX file, or a CRC value obtained by performing a Cyclic Redundancy Check (CRC) of an ODEX file. In addition to the two values, some or all values used to determine whether data is modified may be used as or included in verification information.

The verification data generating unit 213 may add a preset password value (“a preset passcode value”) while generating verification information, to prevent a malicious user from inferring the verification information. Further, at least one checksum algorithm among various checksum algorithms may be used to generate verification information.

The checksum used to generate verification information may be a scheme of calculating the sum of binary numbers by regarding data as a continuity of the binary numbers.

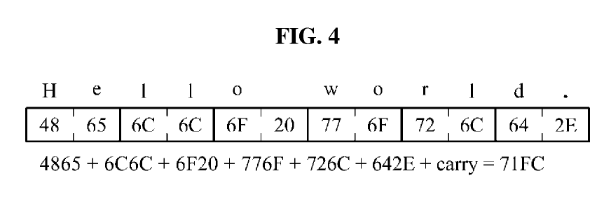

FIG. 4 is a diagram illustrating a method for generating a verification sum used to generate verification information to verify a virtualization module according to an exemplary embodiment of the present invention.

Referring to FIG. 4, to generate verification information using a 16-bit checksum, the verification data generating unit 213 may obtain data in hexadecimal notation, by dividing the data by every 16 bits, may calculate the sum of hexadecimal numbers, and may determine a value corresponding to the remainder after dividing the sum by 16 as verification information.

If the data is expressed in hexadecimal notation by dividing the data by every 16 bits and the sum of hexadecimal numbers is calculated, an additionally added ‘carry’ of FIG. 4 may be used as a preset password value that prevents a user from inferring the verification information or another preset password value may be added. According to a checksum algorithm, the ‘carry’ may be subtracted or may not be used. Further, different ‘carry’ values may be used according to checksum algorithms. Further, a random value may be generated while the application is being installed or being updated and may be stored in the memory. The random value may be added to the checksum value or the CRC value to differentiate the verification information for a specific terminal apparatus.

The virtualization module loading unit 214 may load an ODEX file from the memory unit 230, in response to a request to execute an application. The ODEX file may refer to a virtualization module corresponding to the application.

The verification data extracting unit 215 may extract verification data from the ODEX file loaded by the virtualization module loading unit 214. If verification data is not extracted from the ODEX file, the verification data extracting unit 215 may control the execution of the application to be terminated.

The verification table retrieving unit 216 may retrieve verification data corresponding to the ODEX file from the verification table stored in the memory unit 230. If the verification data corresponding to the ODEX file does not exist in the verification table, the verification table retrieving unit 216 may control the execution of the application to be terminated.

The comparison and verification unit 217 may compare the verification data retrieved by the verification table retrieving unit 216 with the verification data extracted by the verification data extracting unit 215. If the retrieved verification data from the verification table matches, corresponds to, or is identical to the extracted verification data from the ODEX file, the comparison and verification unit 217 may determine that the ODEX file is not abnormally modified. If the retrieved verification data is different from the extracted verification data, the comparison and verification unit 217 may determine that the ODEX file is abnormally modified.

Further, the comparison and verification unit 217 may compare the verification data retrieved by the verification table retrieving unit 216 and/or the verification data extracted by the verification data extracting unit 215 with the verification data generated by the verification data generating unit 213. If the retrieved verification data, the extracted verification data, and the generated verification data match, correspond to, or are identical to each other, the comparison and verification unit 217 may determine that the ODEX file is not abnormally modified. If at least one among the retrieved verification data, the extracted verification data, and the generated verification data does not match with the other two, the comparison and verification unit 217 may determine that the ODEX file is abnormally modified.

The reliability evaluating unit 218 may evaluate reliability of an application a user requests to install and reliability of update data, and may stop installation of the application or the update data if the reliability of the application or the reliability of the update data is evaluated to be lower than a threshold value.

The reliability evaluating unit 218 may evaluate the reliability of the application or the update data, before receiving the application or the update data, or before installing the received application or the received update data.

The reliability evaluating unit 218 may evaluate reliability using various schemes. Hereinafter, an example in which the reliability evaluating unit 218 evaluates reliability will be described.

The reliability evaluating unit 218 may request a separate server to evaluate reliability of an application, may receive a reliability evaluation result from the separate server, and may check the reliability of the application. The separate server may be used to evaluate reliability of an application or update data.

The reliability evaluating unit 218 may retrieve an application from the reliability DB 240 and may evaluate reliability of the retrieved application.

The reliability evaluating unit 218 may receive reliability information regarding an application from a server that is used to supply the application, may determine whether the reliability information satisfies a criterion stored in the reliability criterion DB 250, and may evaluate reliability of the application.

For example, if criterion information indicates an application that is generated by a producer A and sold by a merchant server P and if a target application that a user is considering to install satisfies the criterion information, the target application may be determined to be reliable.

Further, if a merchant server that receives a supplied application is identical to a producer or an authorized entity in association with the producer, the reliability evaluating unit 218 may determine that update data is reliable.

The control unit 210 may control a portion of or all the operation of the terminal apparatus 200. Further, the control unit 210 may perform one or more operations of the downloading unit 211, the VM unit 212, the verification data generating unit 213, the virtualization module loading unit 214, the verification data extracting unit 215, the verification table retrieving unit 216, the comparison and verification unit 217, and the reliability evaluating unit 218. To facilitate the description of the aforementioned functions and operations, FIG. 2 separately illustrates the control unit 210, the downloading unit 211, the VM unit 212, the verification data generating unit 213, the virtualization module loading unit 214, the verification data extracting unit 215, the verification table retrieving unit 216, the comparison and verification unit 217, and the reliability evaluating unit 218. The control unit 210 may include at least one processor configured to perform a portion of or all the operations of the downloading unit 211, the VM unit 212, the verification data generating unit 213, the virtualization module loading unit 214, the verification data extracting unit 215, the verification table retrieving unit 216, the comparison and verification unit 217, and the reliability evaluating unit 218.

FIG. 3 is a block diagram illustrating a terminal apparatus to manage a virtualization module according to an exemplary embodiment of the present invention.

Referring to FIG. 3, the terminal apparatus 300 may include a control unit 310, a downloading unit 311, a VM unit 312, a verification data generating unit 313, a virtualization module loading unit 314, a verification table retrieving unit 316, a comparison and verification unit 317, a communication unit 320, and a memory unit 330. Further, the terminal apparatus 300 may include at least one of a reliability evaluating unit 318, a reliability database (DB) 340, and a reliability criterion database (DB) 350.

The downloading unit 311, the VM unit 312, the virtualization module loading unit 314, the verification table retrieving unit 316, the reliability evaluating unit 318, the communication unit 320, the memory unit 330, the reliability DB 340, and the reliability criterion DB 350 in the terminal apparatus 300 of FIG. 3 may perform substantially similar operations as the downloading unit 211, the VM unit 212, the virtualization module loading unit 214, the verification table retrieving unit 216, the reliability evaluating unit 218, the communication unit 220, the memory unit 230, the reliability DB 240, and the reliability criterion DB 250 in the terminal apparatus 200 of FIG. 2, respectively. Accordingly further description thereof will be omitted.

The verification data generating unit 313 may generate verification data, and may store the generated verification data in a verification table of the memory unit 330. The verification data may be used to verify an ODEX file.

In response to a request to execute an application, the verification data generating unit 313 may generate verification data using an ODEX file corresponding to an application loaded by the virtualization module loading unit 314 and may provide the generated verification data to the comparison and verification unit 317.

If the ODEX file is modified due to an installation of update data, the verification data generating unit 213 may generate modified verification data, and may update the verification data stored in the verification table with the modified verification data. The update procedure of the verification data stored in the verification table may be secured by an access authorization and/or a modification authorization to the verification table. The verification data stored in the verification table may be updated if update data for updating ODEX file is originated from a reliable source. The reliable source may be the download source of the installed application. The reliability of the reliable source may be determined by Internet Protocol (IP) of the reliable source, an authorization code established between the reliable source and the terminal apparatus, and the like.

Since the generated verification data is not inserted in the ODEX file by the verification data generating unit 313, the verification data generating unit 313 may be distinct from the verification data generating unit 213 of FIG. 2. Thus, the generated verification data may be stored in the verification table and may not be inserted in the ODEX file. For a verification of the ODEX file, verification data may be obtained from the ODEX file by applying a preset algorithm, such as a checksum, and the obtained verification data may be compared with the verification data stored in the verification table.

The comparison and verification unit 317 may compare the verification data retrieved by the verification table retrieving unit 316 with the verification data generated by the verification data generating unit 313. The verification data generating unit 313 may generate the verification data based on the ODEX file that exists when the generation of the verification data is performed using a preset algorithm. If the retrieved verification data matches the generated verification data, the comparison and verification unit 317 may determine that the ODEX file is not abnormally modified. If the retrieved verification data does not match the generated verification data, the comparison and verification unit 317 may determine that the ODEX file is abnormally modified.

The control unit 310 may control a portion of or all the operation of the terminal apparatus 300. Further, the control unit 310 may perform one or more operations of the downloading unit 311, the VM unit 312, the verification data generating unit 313, the virtualization module loading unit 314, the verification table retrieving unit 316, the comparison and verification unit 317, and the reliability evaluating unit 318. To facilitate the description of the aforementioned functions and operations, FIG. 3 separately illustrates the control unit 310, the downloading unit 311, the VM unit 312, the verification data generating unit 313, the virtualization module loading unit 314, the verification table retrieving unit 316, the comparison and verification unit 317, and the reliability evaluating unit 318. The control unit 310 may include at least one processor configured to perform a portion of or all the operations of the downloading unit 311, the VM unit 312, the verification data generating unit 313, the virtualization module loading unit 314, the verification table retrieving unit 316, the comparison and verification unit 317, and the reliability evaluating unit 318.

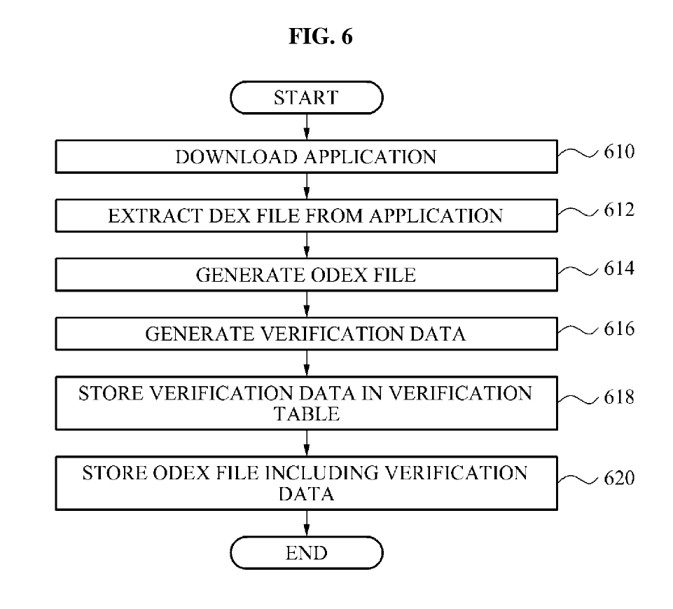

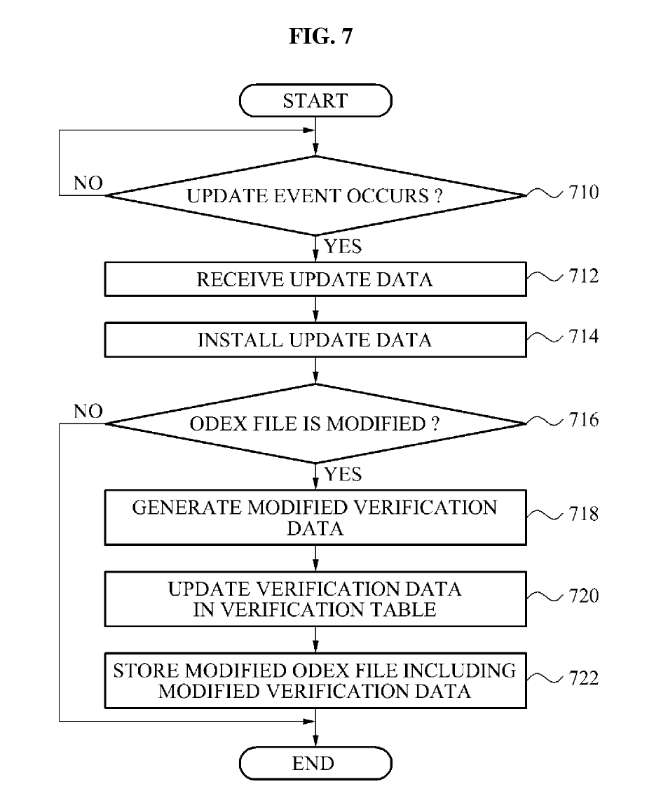

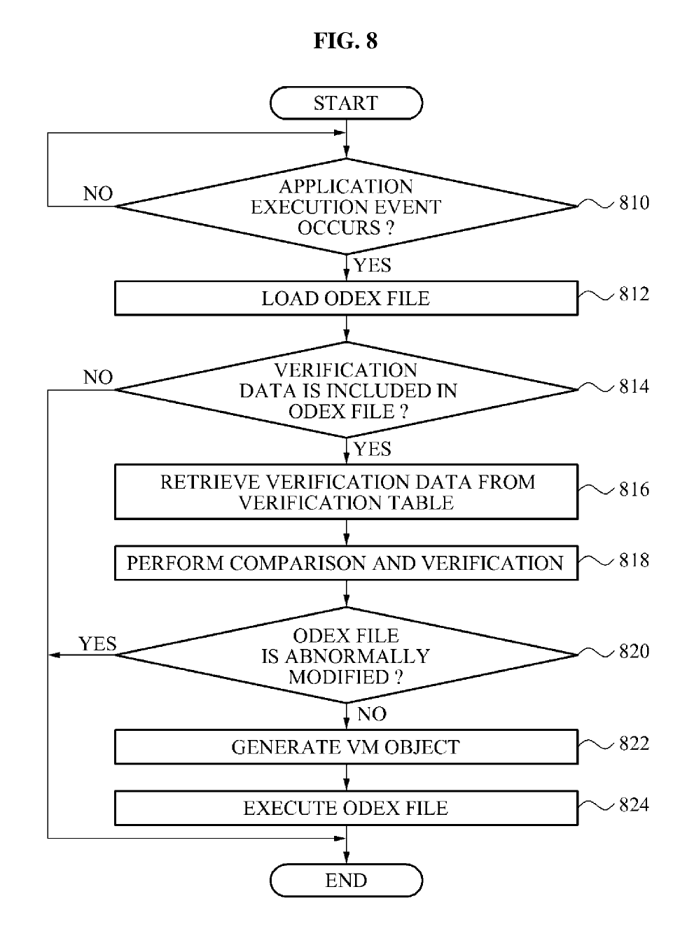

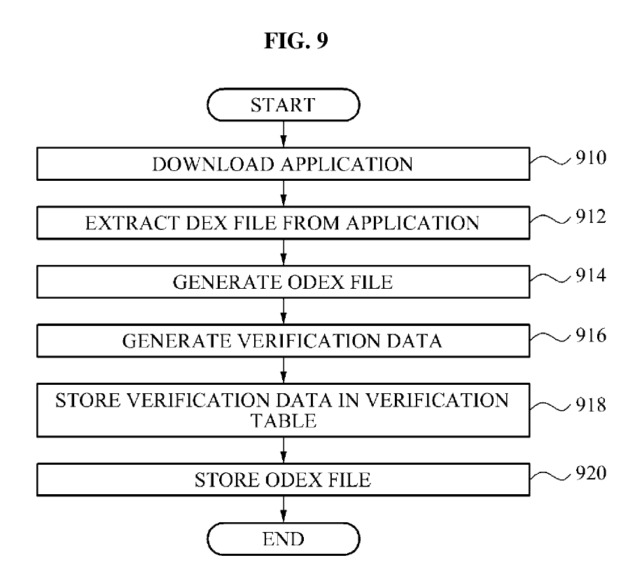

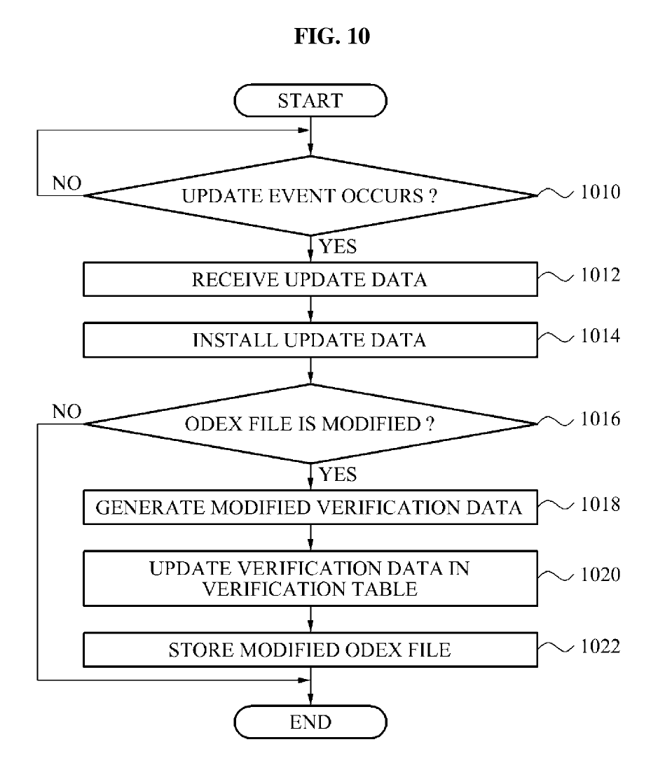

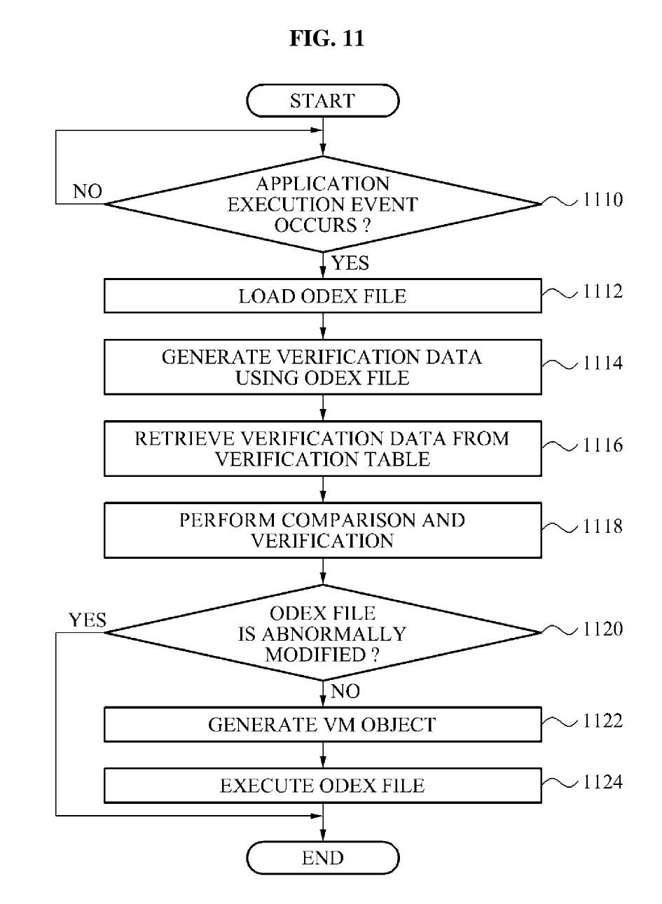

Hereinafter, a method for managing a virtualization module will be described with reference to FIG. 6, FIG. 7, FIG. 8, FIG. 9, FIG. 10, and FIG. 11.

FIG. 6 is a flowchart illustrating a method for setting an application in a terminal apparatus according to an exemplary embodiment of the present invention. FIG. 6 will be described as if performed by terminal apparatus 200 shown in FIG. 2, but is not limited as such.

Referring to FIG. 6, in operation 610, the terminal apparatus 200 may download an application, such as one selected by a user or one that a user desires to install, from a merchant server. In operation 612, the terminal apparatus 200 may extract a DEX file from an application in an APK file format. In operation 614, the terminal apparatus 200 may generate an ODEX file by optimizing the DEX file for the terminal apparatus 200.

In operation 616, the terminal apparatus 200 may generate verification data that may be used to verify the ODEX file. In operation 618, the terminal apparatus 200 may store the generated verification data in a verification table. In operation 620, the terminal apparatus 200 may store the ODEX file including the verification data.

FIG. 7 is a flowchart illustrating a method for updating an application in a terminal apparatus according to an exemplary embodiment of the present invention. FIG. 7 will be described as if performed by terminal apparatus 200 shown in FIG. 2, but is not limited as such.

Referring to FIG. 7, if an occurrence of an update event for an application is detected in operation 710, the terminal apparatus 200 may receive update data from an application merchant server in operation 712.

In operation 714, the terminal apparatus 200 may install the received update data.

In operation 716, the terminal apparatus 200 may determine whether the ODEX file is modified due to installation of the update data.

If it is determined that the ODEX file remains unmodified in operation 716, the terminal apparatus 200 may disregard following operations 718, 720, and 722.

If it is determined that the ODEX file is modified in operation 716, the terminal apparatus 200 may generate modified verification data in operation 718. The modified verification data may be used to verify the modified ODEX file.

In operation 720, the terminal apparatus 200 may update the verification data stored in the verification table with the modified verification data. The previous verification data stored in the verification table may be preserved in association with corresponding version information of the application, and the modified verification data may be stored in association with corresponding version information of the application. In operation 722, the terminal apparatus 200 may store the modified ODEX file including the modified verification data.

FIG. 8 is a flowchart illustrating a method for executing an application in a terminal apparatus according to an exemplary embodiment of the present invention. FIG. 8 will be described as if performed by terminal apparatus 200 shown in FIG. 2, but is not limited as such.

Referring to FIG. 8, if an occurrence of an application execution event is detected in operation 810, the terminal apparatus 200 may load an ODEX file in operation 812. The ODEX file may be a virtualization module corresponding to the application.

In operation 814, the terminal apparatus 200 may determine whether verification data is included in the loaded ODEX file.

If it is determined that the verification data is included in the ODEX file in operation 814, the terminal apparatus 200 may retrieve verification data corresponding to the ODEX file from the corresponding verification table.

In operation 818, the terminal apparatus 200 may compare the verification data in the verification table with the verification data in the ODEX file. In operation 820, the terminal apparatus 200 may determine whether the ODEX file is abnormally modified. If the verification data in the verification table matches the verification data in the ODEX file, the terminal apparatus 200 may determine that the ODEX file is not abnormally modified. If the verification data in the verification table does not match the verification data in the ODEX file, the terminal apparatus 200 may determine that the ODEX file is abnormally modified. If the ODEX file is determined to be abnormally modified, the terminal apparatus 200 may perform a secured verification procedure for the ODEX file, such as virus scanning, and/or may recover the genuine ODEX file.

If it is determined that the ODEX file is not abnormally modified in operation 820, the terminal apparatus 200 may generate a VM object corresponding to the application in operation 822. Then, the terminal apparatus 200 may execute the ODEX file using the generated VM object in operation 824.

If it is determined that the verification data is not included in the ODEX file in operation 814 or if it is determined that the ODEX file is abnormally modified in operation 820, the terminal apparatus 200 may disregard the operations 822 and 824.

FIG. 9 is a flowchart illustrating a method for setting an application in a terminal apparatus according to an exemplary embodiment of the present invention. FIG. 9 will be described as if performed by terminal apparatus 300 shown in FIG. 3, but is not limited as such.

Referring to FIG. 9, in operation 910, the terminal apparatus 300 may download an application that a user has selected or that the user desires to install, from a merchant server. In operation 912, the terminal apparatus 300 may extract a DEX file from an application in an APK file format. In operation 914, the terminal apparatus 300 may generate an ODEX file by optimizing the DEX file for the terminal apparatus 300.

In operation 916, the terminal apparatus 300 may generate verification data used to verify the ODEX file. In operation 918, the terminal apparatus 300 may store the generated verification data in a verification table. In operation 920, the terminal apparatus 300 may store the ODEX file. The ODEX file stored in operation 920 may not include the verification data.

FIG. 10 is a flowchart illustrating a method for updating an application in a terminal apparatus according to an exemplary embodiment of the present invention. FIG. 10 will be described as if performed by terminal apparatus 300 shown in FIG. 3, but is not limited as such.

Referring to FIG. 10, if an occurrence of an update event for an application is detected in operation 1010, the terminal apparatus 300 may receive update data from an application merchant server in operation 1012.

In operation 1014, the terminal apparatus 300 may install the received update data.

In operation 1016, the terminal apparatus 300 may determine whether the ODEX file is modified due to installation of the update data.

If it is determined that the ODEX file remains unmodified in operation 1016, the terminal apparatus 300 may disregard the following operations 1018, 1020, and 1022.

If it is determined that the ODEX file is modified in operation 1016, the terminal apparatus 300 may generate modified verification data using the modified ODEX file in operation 1018. The modified verification data may be used to verify the modified ODEX file.

In operation 1020, the terminal apparatus 300 may update the verification data stored in the verification table with the modified verification data. The previous verification data stored in the verification table may be preserved in association with corresponding version information of the application, and the modified verification data may be stored in association with corresponding version information of the application. In operation 1022, the terminal apparatus 300 may store the modified ODEX file. The modified ODEX file stored in operation 1022 may not include the modified verification data.

FIG. 11 is a flowchart illustrating a method for executing an application in a terminal apparatus according to an exemplary embodiment of the present invention. FIG. 11 will be described as if performed by terminal apparatus 300 shown in FIG. 3, but is not limited as such.

Referring to FIG. 11, if an occurrence of an application execution event is detected in operation 1110, the terminal apparatus 300 may load an ODEX file in operation 1112. The ODEX file may be a virtualization module corresponding to the application.

In operation 1114, the terminal apparatus 300 may generate verification data using the loaded ODEX file.

In operation 1116, the terminal apparatus 300 may retrieve verification data corresponding to the ODEX file from a verification table.

In operation 1118, the terminal apparatus 300 may compare the retrieved verification data with the generated verification data. In operation 1120, the terminal apparatus 300 may determine whether the ODEX file is abnormally modified, based on a result of operation 1118. If the retrieved verification data matches the generated verification data, the terminal apparatus 300 may determine that the ODEX file is not abnormally modified. If the retrieved verification data does not match the generated verification data, the terminal apparatus 300 may determine that the ODEX file is abnormally modified.

If it is determined that the ODEX file is not abnormally modified in operation 1120, the terminal apparatus 300 may generate a VM object corresponding to the application in operation 1122. Then, the terminal apparatus 300 may execute the ODEX file using the generated VM object in operation 1124.

If it is determined that the ODEX file is abnormally modified in operation 1120, the terminal apparatus 300 may disregard the operations 1122 and 1124.

The methods according to embodiments of the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

According to exemplary embodiments of the present invention, verification data may be generated and managed for each virtualization module, and thus it may be possible to determine whether a virtualization module is abnormally modified, based on the corresponding verification data and to prevent the virtualization module from being executed when the virtualization module is determined to be abnormally modified by a user.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to manage a virtualization module, comprising:
a virtualization module managing unit to retrieve a virtualization module corresponding to an application;
a verification table retrieving unit to retrieve first verification data corresponding to the virtualization module from a verification table;
a verification unit to verify the virtualization module, based on the first verification data and the virtualization module;
a processor; and
a virtual machine unit to execute, using the processor, the virtualization module using a virtual machine if the virtualization module is successfully verified.

2. The apparatus of claim 1, further comprising:
a verification data generating unit to obtain second verification data from the virtualization module; and
a comparison unit to compare the second verification data with the first verification data,
wherein the virtualization module is successfully verified by the verification unit if the second verification data matches the first verification data.

3. The apparatus of claim 1, wherein the virtualization module comprises a virtual machine executable instruction that is executable by the virtual machine.

4. The apparatus of claim 2, wherein the second verification data comprises at least one of a checksum value of the virtualization module, a cyclic redundancy check value associated with the virtualization module, and a passcode value.

5. The apparatus of claim 1, wherein the virtualization module is optimized for the virtual machine or an operating system executed by the processor.

6. The apparatus of claim 1, wherein the first verification data is stored in a memory during an installation process of the application.

7. The apparatus of claim 1, wherein the virtualization module is derived from an application package file of the application and is stored separately from the application package file.

8. An apparatus to manage a virtualization module, comprising:
a downloading unit to install an application that is executable using a virtual machine;
a processor;
a verification data generating unit to generate, using the processor, first verification data from a virtualization module corresponding to the application; and
a memory to store the first verification data and corresponding application information in a verification table, the first verification data being associated with the corresponding application information in the verification table.

9. The apparatus of claim 8, wherein the first verification data comprises at least one of a checksum value of the virtualization module, a cyclic redundancy check value associated with the virtualization module, and a passcode value, and
the virtualization module comprises a virtual machine executable instruction that is executable by the virtual machine.

10. The apparatus of claim 8, further comprising a control unit to authorize a modification of the virtualization module, wherein
the downloading unit generates a modified virtualization module if the virtualization module is authorized to be modified,
the verification data generating unit generates second verification data from the modified virtualization module, and
the memory stores the second verification data in the verification table, the second verification data being associated with the corresponding application information in the verification table.

11. A method for managing a virtualization module, comprising:
retrieving a virtualization module corresponding to an application;
retrieving first verification data corresponding to the virtualization module from a verification table;
verifying the virtualization module, based on the first verification data and the virtualization module; and
executing, using a processor, the virtualization module using a virtual machine if the virtualization module is successfully verified.

12. The method of claim 11, further comprising:
obtaining second verification data from the virtualization module; and
comparing the second verification data with the first verification data,
wherein the virtualization module is successfully verified if the second verification data matches the first verification data.

13. The method of claim 11, wherein the virtualization module comprises a virtual machine executable instruction that is executable by the virtual machine.

14. The method of claim 12, wherein the second verification data comprises at least one of a checksum value of the virtualization module, a cyclic redundancy check value associated with the virtualization module, and a passcode value.

15. The method of claim 11, wherein the virtualization module is optimized for the virtual machine or an operating system executed by the processor.

16. The method of claim 11, wherein the first verification data is stored in a memory during an installation process of the application.

17. The method of claim 11, wherein the virtualization module is derived from an application package file of the application and is stored separately from the application package file.

18. A method for managing a virtualization module, comprising:
installing an application that is executable using a virtual machine;
generating, using a processor, first verification data from a virtualization module corresponding to the application; and
storing the first verification data and corresponding application information in a verification table, the first verification data being associated with the corresponding application information in the verification table.

19. The method of claim 18, further comprising:
generating the virtualization module using an application package file of the application; and
storing the virtualization module in association with the application package file.

20. The method of claim 18, wherein the first verification data comprises at least one of a checksum value of the virtualization module, a cyclic redundancy check value associated with the virtualization module, and a passcode value, and
the virtualization module comprises a virtual machine executable instruction that is executable by the virtual machine.

21. The method of claim 18, further comprising:
evaluating reliability of the application, based on reliability information of the application, the reliability information comprising at least one of a reliable category, a reliable producer, a reliable merchant server, a reliable criterion release date, and a reliable authority.

22. The method of claim 18, further comprising:
authorizing a modification of the virtualization module;
generating a modified virtualization module if the virtualization module is authorized to be modified;
generating second verification data from the modified virtualization module; and
storing the second verification data in the verification table, the second verification data being associated with the corresponding application information in the verification table.

23. The method of claim 22, wherein the modification of the virtualization module is authorized if the modification of the virtualization module is an authorized process of updating the application.
